(19) United States
(12) Patent Application Publication
(10) Pub. No.: US 2005/0154573 A1
(43) Pub. Date: Jul. 14, 2005

(54) Systems and methods for initializing a lockstep mode test case simulation of a multi-core processor design

(76) Inventors: John Warren Maly, Laporte, CO (US); Ryan Clarence Thompson, Loveland, CO (US); Zachary Steven Smith, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/753,676

(22) Filed: Jan. 8, 2004

(51) Int. Cl. G06F 9/44

(52) U.S. Cl. 703/21

(57) ABSTRACT

Systems, methods and software products are provided for lockstep mode test case initialization of a multi-core processor. One or more initialization statements of the test case simulation are determined that identify one or more first registers of a simulated primary core. If the test case simulation specifies that the multi-core processor design operates in lockstep mode, scope of the initialization statements is modified. The first registers specified by the initialization statements are initialized, and unmodified initialization statements are processed to initialize second registers of simulated cores of the multi-core processor design, as specified by the unmodified initialization statements.

### BACKGROUND

In a multi-core processor system, each processor is constructed from two or more processing cores. Each core may be utilized independently to increase system performance. Or, the cores may be used in a ‘lockstep’ mode to improve data integrity. Multiple cores operating in lockstep have a common instruction stream and a synchronized clock. The results of each instruction are expected to be identical for each core. Although the cores share the synchronized clock, each core's state, registers and internal data paths are never checked for agreement; only external activity of the processing cores is compared.

If one of the cores experiences a radiation event disturbance (i.e., where one signal within the core is momentarily corrupted by a particle of radiation) or develops a hardware fault, the core may execute an incorrect instruction, and/or use incorrect data, thereby producing incorrect results. Results of each instruction are therefore compared between cores to detect errors. If the results match for all cores, the processor continues with the next instruction; if the results do not match for all cores, a fault recovery action is triggered and the processor attempts recovery from the error (e.g., by back-tracking and repeating one or more instructions). Where a multi-core processor includes three or more cores operating in lockstep mode, a voting system may be used to decide which core is in error when instruction results do not match for all cores.

Data integrity in multi-core processors operating in lockstep mode is therefore higher than for single core processors or multi-core processors that do not operate in lockstep mode.

Each processor core contains volatile registers and memory that define the operating state of the processor. The contents of the registers and memory are lost when power is removed from the processor. When power is applied to the processor, these registers and memory initially contain random data, setting the processor into a ‘non-deterministic’ state. A series of ‘resets’ are therefore applied within the processor to initialize one or more of these registers and memory to achieve a ‘deterministic’ state, before the processor starts normal operation. This series of resets is commonly known as a ‘power-on reset.’

During development of the processor, one or more test cases are created that specify tests (and optionally expected results) for the processor. Each test case may also specify a set of initial values for the registers and memory of the processor, and a set of instructions for the processor to execute. The processor is then simulated by a simulator (e.g., the simulator loads an electronic design of the processor to create a simulation model within memory), which simulates the processor's execution of instructions within each test case to verify correct operation of the processor. In one example, the simulator simulates a power-on reset process to initialize the state of each core.

However, because the simulation slowly reaches a deterministic state for the processor, registers and memory within the processor simulation are often initialized by an initializer, which removes the need to simulate the power-on reset. In particular, the initializer reads the test case and modifies the initial state of the simulated processor to set register and memory contents to specified values as specified by the test case. Once the processor is initialized, the simulator simulates execution of the instruction set, specified in the test case, and verifies that output from the simulated processor is as expected.

In the case of lockstep mode simulation, it is important that each simulated core of the processor is similarly initialized. Thus, each test case must specify correct initialization values for each simulated processor core. Omitted or erroneous initialization values usually result in incorrect operation of the processor. Therefore, it is important that each test case has proper initialization definitions for each simulated processor core; this initialization is error prone and time consuming.

### SUMMARY OF THE INVENTION

In one embodiment, a method initializes a lockstep mode test case simulation of a multi-core processor design. One or more initialization statements of the test case simulation are determined that identify one or more first registers of a simulated primary core. If the test case simulation specifies that the multi-core processor design operates in lockstep mode, scope of the initialization statements is modified. The first registers specified by the initialization statements are initialized, and unmodified initialization statements are processed to initialize second registers of simulated cores of the multi-core processor design, as specified by the unmodified initialization statements.

In another embodiment, a system initializes a lockstep mode test case simulation of a multi-core processor design, including: means for determining one or more initialization statements of the test case simulation that identify one or more first registers of a simulated primary core; means for modifying scope of the initialization statements when the test case simulation specifies that the multi-core processor design operates in lockstep mode; means for initializing the first registers specified by the initialization statements; and means for processing unmodified initialization statements to initialize second registers of simulated cores of the multi-core processor design, as specified by the unmodified initialization statements.

In another embodiment, a software product comprises of instructions, stored on computer-readable media, wherein the instructions, when executed by a computer, perform steps for initializing a lockstep mode test case simulation of a multi-core processor design, including: instructions for determining one or more initialization statements of the test case simulation that identify one or more first registers of a simulated primary core; instructions for modifying scope of the initialization statements when the test case simulation specifies that the multi-core processor design operates in lockstep mode; instructions for initializing the first registers specified by the initialization statements; and instructions for processing unmodified initialization statements to initialize second registers of simulated cores of the multi-core processor design, as specified by the unmodified initialization statements.

In another embodiment, a system initializes a lockstep mode test case simulation of a multi-core processor design. The system has a lockstep core initializer. A simulated multi-core processor has a simulated primary core and one or more other simulated cores. A test case includes one or more primary core initialization statements. A lockstep core initializer processes the initialization statements to identify one or more first registers of the simulated primary core. If the lockstep core initializer determines that the test case simulation specifies that the multi-core processor design operates in lockstep mode, the lockstep core initializer (a) modifies scope of the initialization statements, (b) initializes the first registers specified by the initialization statements, and (c) processes unmodified initialization statements to initialize second registers of simulated cores of the multi-core processor design.

### BRIEF DESCRIPTION OF THE FIGURES

FIG. 1 is a flowchart illustrating one system for initializing a lockstep mode test case simulation of a multi-core processor design.

FIG. 2 is a block diagram illustrating one initialization of a simulation.

FIG. 3 is a block diagram illustrating exemplary data flow and logic control for initializing a lockstep mode test case simulation of a multi-core processor design.

FIG. 4 is a flowchart illustrating one process for initializing a lockstep mode test case simulation of a multi-core processor design.

### DETAILED DESCRIPTION OF THE FIGURES

During development of a multi-core processor, a processor design is repeatedly simulated, using one or more test cases, to verify correct operation. To operate in a lockstep mode, each core of the processor design should be initialized to the same state. Therefore, prior to simulating each test case, certain registers and memory locations within each core of the processor design are initialized as specified by the test case(s), to achieve a known deterministic state for the processor design and without simulating a power-on reset.

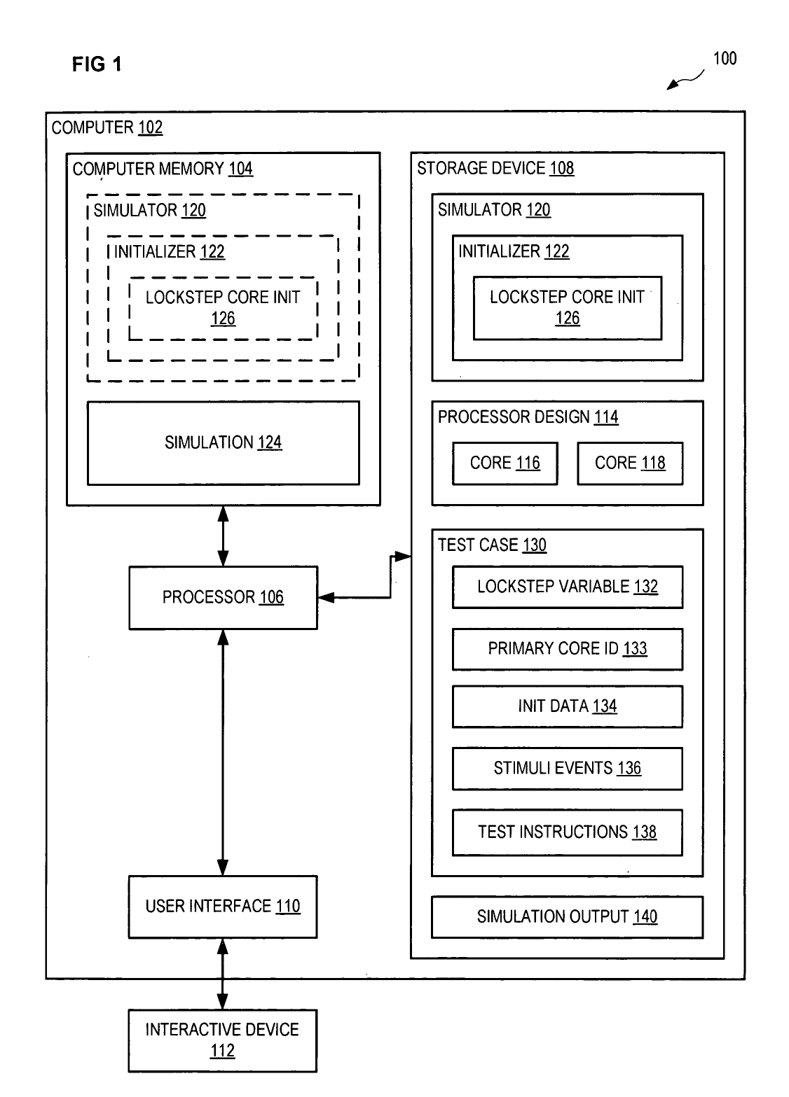

FIG. 1 is a block diagram illustrating one system 100 for initializing a lockstep mode test case simulation of a multi-core processor. System 100 includes a computer 102 that has computer memory 104, a processor 106, a storage device 108, and a user interface 110. System 100 also includes an interactive device 112 connected to user interface 110 of computer 102. Interactive device 112 is, for example, a computer terminal used by a verification engineer to interact with computer 102. Storage device 108 is, for example, a disk drive that stores software and data of computer 102.

Storage device 108 is shown with a simulator 120, a processor design 114, a test case 130 and simulation output 140. Simulator 120 illustratively includes an initializer 122 and a lockstep core initializer 126, described below. In operation, a verification engineer enters a request, at interactive device 112, to instruct processor 106 to load simulator 120 into computer memory 104, for execution therein. Simulator 120, initializer 122 and lockstep core initializer 126 are thus shown as dashed lines within computer memory 104, for purposes of illustration. Initializer 122 and lockstep core initializer 126 may be separate software components from simulator 120 as a matter of design choice.

In the embodiment of FIG. 1, processor design 114 is a multi-core processor and is thus illustratively shown with two processing cores 116 and 118. Additional cores may be included in processor design 114 as a matter of design choice. Storage device 108 is also shown with one test case 130; additional test cases may be included in storage device 108 as a matter of design choice. Test case 130 is shown with a lockstep variable 132, a primary core identifier 133, initialization data 134, stimuli events 136, and test instructions 138, each described in more detail below.

In operation, simulator 120 creates a simulation 124 for processor design 114 in computer memory 104. Simulator 120 may load all or part of processor design 114 into simulation 124. Simulator 120 then simulates operation of processor design 114, using initialization data 134, stimuli events 136 and test instructions 138 of test case 130 to produce simulation output 140 (illustratively shown within storage device 108). In test case 130, lockstep variable 132 specifies whether the current simulation 124 is in lockstep mode; and primary core identifier 133 specifies which core (e.g., core 116 or 118) in processor design 114 is selected as a primary core for simulation 124.

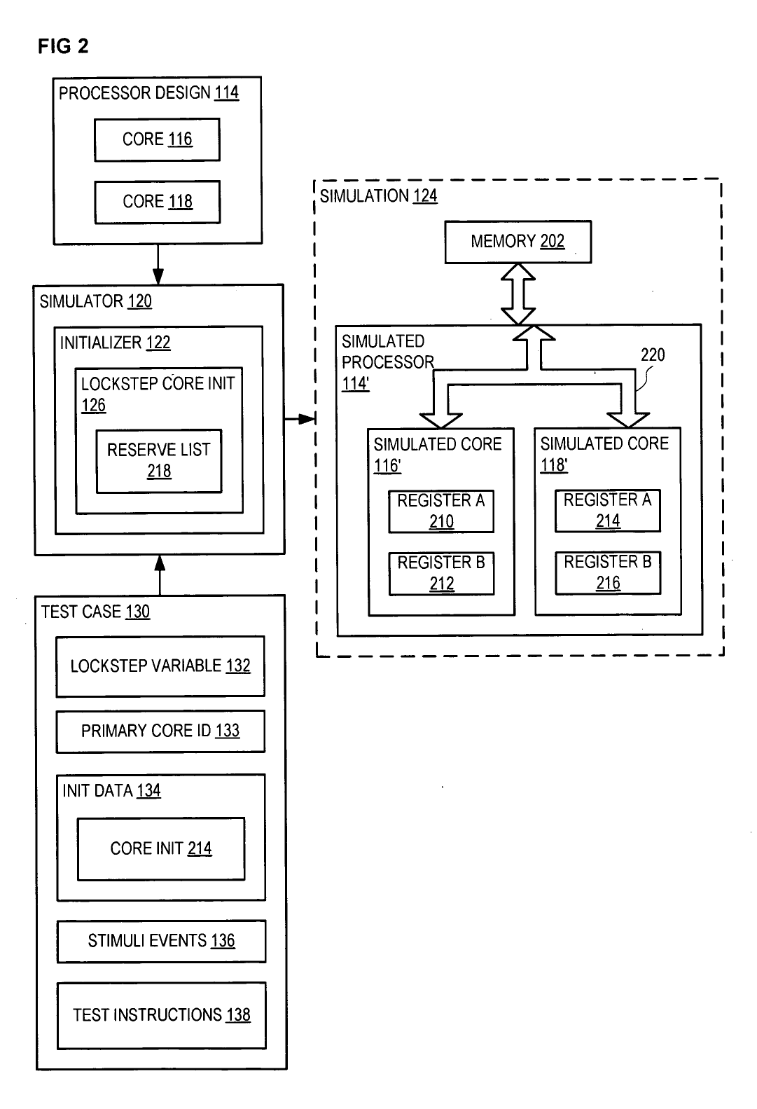

FIG. 2 is a block diagram illustrating one exemplary initialization of simulation 124 by initializer 122. Simulation 124 includes a simulation 114′ of processor design 114, and simulations 116′, 118′ of cores 116 and 118. For purposes of illustration, simulated core 116′ is shown with register 210 and register 212, and simulated core 118′ is shown with register 214 and register 216. Registers 210 and 214 have identical functionality within simulated cores 116′ and 118′, respectively; likewise, registers 212 and 216 have identical functionality within simulated cores 116′ and 118′, respectively. Simulated cores 116′ and 118′ may include additional registers as a matter of design choice. Registers 210 and 212 are, for example, configuration registers that control operation of simulated core 116′. Registers 214 and 216 are, for example, configuration registers that control operation of simulated core 118′.

In FIG. 2, simulation 124 is also shown with a simulated memory 202 that is accessible by both simulated cores 116′ and 118′. Simulated cores 116′ and 118′ share common circuitry within simulated processor 114′, to interface to memory 202, as shown by arrow 220. Arrow 220, for example, represents instruction and data memory caches of simulated processor 114′, accessible by both simulated cores 116′ and 118′.

Initializer 122 reads initialization data 134 of test case 130 and initializes simulation 124. If lockstep variable 132 specifies lockstep mode for simulation 124, initializer 122 utilizes lockstep core initializer 126 to process initialization data 134. Lockstep core initializer 126 reads and processes core initialization 214 (within initialization data 134), initializing registers (e.g., registers 210, 212, 214 and 216) and memory (e.g., memory 202) to specified values.

### PSEUDO CODE EXAMPLE 1

```
Function SetPrimaryCore (Param)
{
    if (lockstep == TRUE)
    {
        if (Param->core == Primary core)
        {
            if (Primary Core already initialized)
            {
                Report Error - Primary Core Set Twice
                Exit
            }
            else
                Set Primary Core to Param->core
        }
    }
    else
        Report Warning - Primary core set but not Lockstep mode
}
```

By way of example, lockstep core initializer 126 implements Pseudo Code Example 1, above, to specify the primary core for simulation 124 during processing of core initialization 214. In Pseudo Code Example 1, function SetPrimaryCore first verifies that lockstep mode is selected for simulation 124 (e.g., lockstep variable 132 specifies lockstep mode). If function SetPrimaryCore does not detect lockstep mode, an error is reported to indicate that a primary core is selected without lockstep mode. Function SetPrimaryCore then verifies that parameter Param specifies initialization information for the primary core; that is, the core identified within Param matches the primary core specified for simulation 124 in primary core identity 133. Function SetPrimaryCore checks that the identified primary core has not yet been initialized for simulation 124. If function SetPrimaryCore detects that the identified primary core has already been initialized, an error is reported. If initialization information of Param specifies the identified primary core, if the primary core has not yet been initialized, and if lockstep mode is selected, then function SetPrimaryCore assigns the initialization information to simulation 124.

Initialization data 134 may be a list of initialization statements, where each statement includes (a) a label that identifies one or more locations within simulated processor 114′ and (b) a value field that specifies an initialization value for those locations. For example, Table 1—Core Initialization Specification 1, below, illustrates exemplary initialization specifications for simulated processor 114′. Each row of Table 1—Core Initialization Specification 1 has four fields: ‘scope’, ‘core’, ‘register’ and ‘value’. The ‘scope’ field specifies the area(s) of simulated processor 114′ initialized by the associated ‘value’ field. For example, a ‘scope’ of CHIP specifies that the associated ‘value’ field applies to the entire processor, and a ‘scope’ of CORE specifies that the associated ‘value’ field applies to only the core identified in the associated ‘core’ field. With reference to Table 1—Core Initialization Specification 1, row 1 has a ‘scope’ of ‘CORE’ that specifies that row 1 applies to a core location. The ‘core’ field of row 1 identifies simulated core 116′. The ‘register’ field of row 1 identifies register ‘A’ (i.e., register A 210), and the ‘value’ field of row 1 specifies an initialization value of 0x1234. Similarly, row 2 specifies an initialization value of 0x5678 for register B of simulated core 116′.

TABLE 1
CORE INITIALIZATION SPECIFICATION 1

| | Scope | Core | Reg | Value |
|---|---|---|---|---|
| Row 1 | CORE | 116′ | A | 0x1234 |
| Row 2 | CORE | 116′ | B | 0x5678 |
| Row 3 | CORE | 118′ | B | 0x9abc |

During exemplary processing of Table 1—Core Initialization Specification 1, lockstep core initializer 126 identifies simulated core 116′ as the primary core of simulated processor 114′. In one embodiment, lockstep core initializer 126 first loads core initialization 214 (e.g., Table 1—Core Initialization Specification 1) into a data structure within lockstep core initializer 126. Lockstep core initializer 126 then utilizes software, exemplified in Pseudo code example 2 below, to process the data structure and identify initialization statements that apply to the primary core (e.g., row 1 and row 2). Lockstep core initializer 126 changes the ‘scope’ of the identified initialization statements to ‘CHIP’, as illustrated in Table 2—Core Initialization Specification 2, below.

TABLE 2
CORE INITIALIZATION SPECIFICATION 2

| | Scope | Core | Reg | Value |
|---|---|---|---|---|
| Row 1 | CHIP | 116′ | A | 0x1234 |
| Row 2 | CHIP | 116′ | B | 0x5678 |
| Row 3 | CORE | 118′ | B | 0x9abc |

Initializer 122 then processes the modified data structure (e.g., Table 2—Core Initialization Specification 2) to initialize simulated processor 114′. Initializer 122 evaluates the scope of each row of Table 2—Core Initialization Specification 2, and applies the initialization value(s) to locations within simulated processor 114′ defined by the scope field. For example, row 1 of Table 2—Core Initialization Specification 2 specifies simulated core 116′ with a scope of ‘CHIP’. Initializer 122 therefore applies the initialization value (i.e., 0x1234) to register A of each simulated core (e.g., simulated cores 116′ and 118′) of simulated processor 114′. This initialization process may be denoted as ‘label promotion’. Thus, initialization statements for the identified primary core of simulated processor 114′ are thereby applied to all simulated cores of simulated processor 114′. Initialization statements not applicable to the identified primary core are not modified, and are applied to simulated processor 114′ after application of the modified initialization statements, thereby overriding primary core initialization statements, if desired.

In one example, initializer 122 first reads lockstep variable 132 from test case 130 to determine if simulation 124 is a lockstep simulation of simulated processor 114′. For purposes of this example, lockstep variable 132 is assumed to indicate that lockstep mode is required for simulation 124. Initializer 122 then loads initialization data 134 into the data structure for processing by lockstep core initialization 126, which implements pseudo code example 2, for example.

### PSEUDO CODE EXAMPLE 2

```
Typedef enum TScope {CHIP=1, CORE=2, THREAD=3} TScope;
if ((Lockstep Enabled) && (Primary Core Initialized) &&
(Specification scope >= CORE))
{
    if (Specification Core == Primary Core)
    {
        Specification Scope = CHIP;
    }
    else
    {
        Add to List( Reserve_list, Specification);
    }
}
```

If lockstep mode is enabled, pseudo code example 2 modifies the scope of initialization statements specific to the identified primary core, within the data structure. In the example of Table 1—Core Initialization Specification 1, pseudo code example 2 modifies the scope field of rows 1 and 2 to ‘CHIP’ (as shown in Table 2—Core Initialization Specification 2), thereby applying the initialization values of rows 1 and 2 to all cores within simulated processor 114′. Initialization statements that do not specify the primary core (e.g., row 3 of Table 1—Core Initialization Specification 1 that specifies core 118) are not modified, are added to list ‘Reserve_list’ (e.g., reserve list 218, FIG. 2), and are processed after application of the primary core initialization statements.

The modifications made to initialization statements within the data structure (by lockstep core initializer 126) prior to application of the initialization statements (by initializer 122) causes initialization statements for the primary core to be applied to all cores of simulated processor 114′ when lockstep mode is specified. Thus, it is not necessary to specify initialization statements for all simulated cores 116′, 118′, reducing required effort and errors.

In one embodiment, initializer 122 may also randomize register values for registers not initialized by initialization data 134, writing the same randomly selected value to matching registers of all cores of processor 114. For example, if register B 212, 216 of cores 116′, 118′, respectively, were not initialized in the above example, they may be initialized with the same randomly selected value, such that each core is identically initialized unless otherwise specified by initialization data 134.

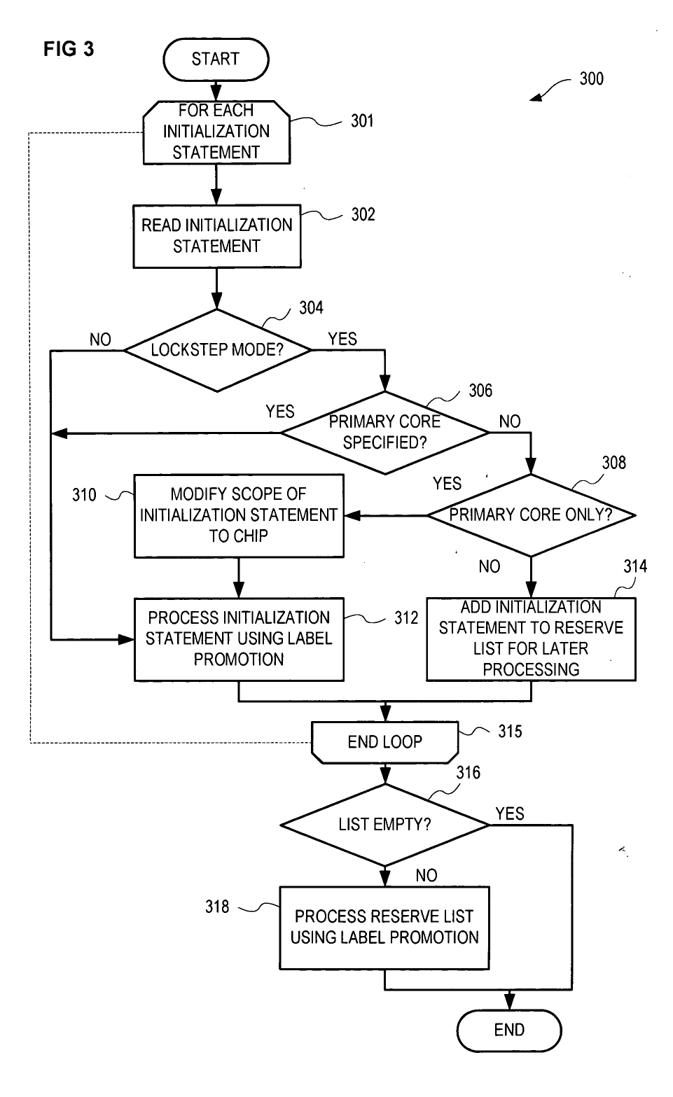

FIG. 3 is a flowchart illustrating one method 300 for initializing a lockstep mode test case simulation of a multi-core processor design. Method 300 is, for example, implemented in initializer 122, FIG. 2. In step 302, method 300 reads an initialization statement from initialization data 134 of tests case 130. In one example of step 302, method 300 reads an initialization statement (e.g., row 1 of Table 1—Core Initialization Specification 1) from initialization data 134 and stores the initialization statement in a data structure within initializer 122.

Step 304 is a decision. In step 304, if lockstep mode is specified (e.g., lockstep variable 132 indicates lockstep mode in test case 130), then method 300 continues with step 306; otherwise method 300 continues with step 312. Step 306 is a decision. In step 306, if the identified primary core of simulated processor 114′ has been specified, method 300 continues with step 312; otherwise method 300 continues with step 308. Step 308 is a decision. In step 308, if the ‘scope’ of the initialization statement, read in step 302, only specifies locations within the identified primary core of simulated processor 114′, method 300 continues with step 310; otherwise method 300 continues with step 314.

In step 310, method 300 modifies the scope field of the initialization statement read in step 302 to ‘CHIP’, such that it applies to all simulated cores within simulated processor 114′. In one example of step 310, method 300 modifies the scope of row 2, Table 1—Core Initialization Specification 1, to ‘CHIP’. In step 312, method 300 processes the initialization statement modified in step 310 to initialize locations identified by the label of the initialization statement. In one example of step 312, method 300 evaluates the scope field of row 2, Table 2—Core Initialization Specification 2, and applies the initialization value 0x5678 to register B 212 of simulated core 116′ and register B 216 of simulated core 118′.

In step 314, method 300 adds the initialization statement, read in step 302, to a list for later processing. In one example of step 314, method 300 adds initialization statement of row 3 Table 1—Core Initialization Specification 1 to reserve list 218 since the scope does not specify locations within the identified primary core of simulated processor 114′, and is therefore applied after the identified primary core is initialized (e.g., after completion of steps 302 through 314).

Steps 302, 304, 306, 308, 310, 312 and 314 are repeated for each initialization statement within initialization data 134 as indicated by for loop boundaries 301 and 315.

Step 316 is a decision. In step 316, if the list of step 314 is empty, method 300 terminates; otherwise method 300 continues with step 318. In step 318, method 300 processes initialization specifications added to the internal list of step 314. In one example of step 318, method 300 evaluates the scope of row 3 Table 1—Core Initialization Specification 1, added to reserve list 218 in step 314, and applies initialization value 0x9abc register B 216 of core 218′, overwriting the previously initialized value 0x5678 of step 312.

Method 300 may be implemented in alternate ways with alternate loop structures without departing from the scope hereof.

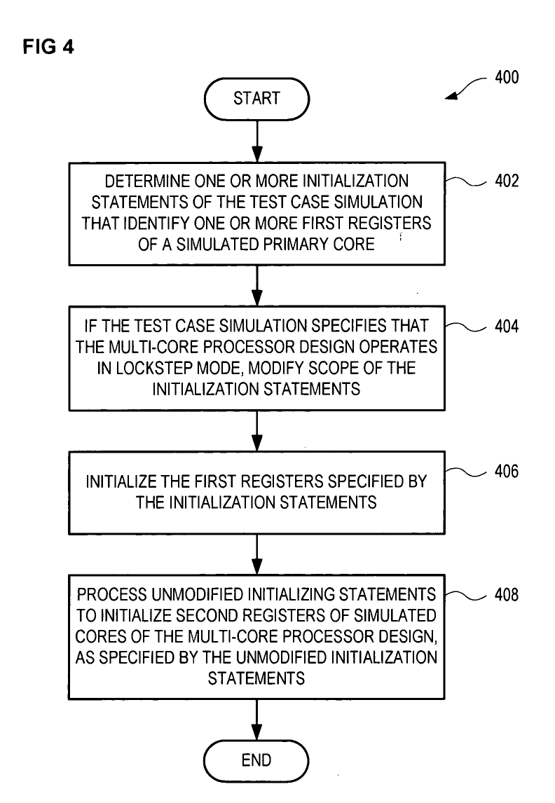

FIG. 4 is a flowchart 1 illustrating one process 400 for initializing a lockstep mode test case simulation of a multi-core processor design. Process 400 is, for example, implemented in lockstep core initializer 126, FIG. 2. In step 402, process 400 determines one or more initialization statements of the test case simulation that identify one or more first registers of a simulated primary core. In step 404, if the test case simulation specifies that the multi-core processor design operates in lockstep mode, process 400 modifies scope of the initialization statements. In step 406, process 400 initializes the first registers specified by the initialization statements. In step 408, process 400 processes unmodified initializing statements to initialize second registers of simulated cores of the multi-core processor design, as specified by the unmodified initialization statements.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

1. A method for initializing a lockstep mode test case simulation of a multi-core processor design, comprising the steps of:
determining one or more initialization statements of the test case simulation that identify one or more first registers of a simulated primary core;
if the test case simulation specifies that the multi-core processor design operates in lockstep mode, modifying scope of the initialization statements;
initializing the first registers specified by the initialization statements; and
processing unmodified initialization statements to initialize second registers of simulated cores of the multi-core processor design, as specified by the unmodified initialization statements.

2. The method of claim 1, the test case simulation comprising one or more test cases.

3. The method of claim 1, wherein the step of initializing comprises loading values from the modified initialization statements into the first registers.

4. The method of claim 1, wherein the step of processing comprises loading values from the unmodified initialization statements into the second registers.

5. The method of claim 1, the step of modifying comprising undesignating the simulated primary core.

6. The method of claim 1, further comprising writing a randomly selected value to non-initialized matching registers of each simulated core.

7. A system for initializing a lockstep mode test case simulation of a multi-core processor design, comprising:
means for determining one or more initialization statements of the test case simulation that identify one or more first registers of a simulated primary core;
means for modifying scope of the initialization statements when the test case simulation specifies that the multi-core processor design operates in lockstep mode;
means for initializing the first registers specified by the initialization statements; and
means for processing unmodified initialization statements to initialize second registers of simulated cores of the multi-core processor design, as specified by the unmodified initialization statements.

8. The system of claim 7, the test case simulation comprising one or more test cases.

9. The system of claim 7, wherein the means for initializing comprises means for loading values from the modified initialization statements into the first registers.

10. The system of claim 7, wherein the means for processing comprises means for loading values from the unmodified initialization statements into the second registers.

11. The system of claim 7, wherein the means for modifying comprising means for undesignating the simulated primary core.

12. The method of claim 7, further comprising means for writing a randomly selected value to non-initialized matching registers of each simulated core.

13. A software product comprising instructions, stored on computer-readable media, wherein the instructions, when executed by a computer, perform steps for initializing a lockstep mode test case simulation of a multi-core processor design, comprising:
instructions for determining one or more initialization statements of the test case simulation that identify one or more first registers of a simulated primary core;
instructions for modifying scope of the initialization statements when the test case simulation specifies that the multi-core processor design operates in lockstep mode;
instructions for initializing the first registers specified by the initialization statements; and
instructions for processing unmodified initialization statements to initialize second registers of simulated cores of the multi-core processor design, as specified by the unmodified initialization statements.

14. The software product of claim 13, the test case simulation comprising one or more test cases.

15. The software product of claim 13, wherein the instructions for initializing comprises instructions for loading values from the modified initialization statements into the first registers.

16. The software product of claim 13, wherein the instructions for processing comprises instructions for loading values from the unmodified initialization statements into the second registers.

17. The software product of claim 13, wherein the instructions for modifying comprising instructions for undesignating the simulated primary core.

18. The software product of claim 13, further comprising instructions for writing a randomly selected value to non-initialized matching registers of each simulated core.

19. A system for initializing a lockstep mode test case simulation of a multi-core processor design, comprising:
a simulated multi-core processor design with a simulated primary core and one or more other simulated cores; and
a test case with one or more primary core initialization statements;
a lockstep core initializer for processing the initialization statements to identify one or more first registers of the simulated primary core, wherein if the lockstep core initializer determines that the test case simulation specifies that the multi-core processor design operates in lockstep mode, the lockstep core initializer (a) modifies scope of the initialization statements, (b) initializes the first registers specified by the initialization statements, and (c) processes unmodified initialization statements to initialize second registers of simulated cores of the multi-core processor design.
